(19) United States
(12) Patent Application Publication
(10) Pub. No.: US 2009/0037356 A1
(43) Pub. Date: Feb. 5, 2009

(54) SYSTEMS AND METHODS FOR GENERATING SALES LEADS DATA

(76) Inventors: Russell Rothstein, Toronto (CA); Mark C. Dhas, Oakville (CA); Juvenal Flores, Toronto (CA)

Correspondence Address: BERESKIN AND PARR, 40 KING STREET WEST, BOX 401, TORONTO, ON, M5H 3Y2, CA

(21) Appl. No.: 12/183,448

(22) Filed: Jul. 31, 2008

Related U.S. Application Data
(60) Provisional application No. 60/935,282, filed on Aug. 3, 2007.

(51) Int. Cl. G06N 5/02; G06F 7/06; G06F 17/30

(52) U.S. Cl. 706/46; 707/10; 707/E17.008; 707/E17.006

(57) ABSTRACT

A method and system for generating sales leads information from a plurality of online sources is disclosed. The method includes the following steps:

collecting the sales lead information from the plurality of online sources;

transforming the sales leads information into a data record;

classifying the data record containing the sales lead information according to at least one predetermined characteristic; and

storing the data record.

The system includes a data collector module, a data processor module, a translation mapping engine, and a data store. The data collector module collects the sales lead information from the plurality of online sources. The data processor module transforms the sales lead information into a data record. The translation mapping engine classifies the data record containing the sales lead information according to at least one predetermined characteristic. The data store stores the data record.

### CROSS-REFERENCE TO RELATED APPLICATIONS

This application claims priority from U.S. Provisional Patent Application 60/935,282, filed on Aug. 3, 2007, which is incorporated herein by reference in its entirety.

### TECHNICAL FIELD

The invention relates to generating sales leads. More particularly, the invention relates to systems and methods for generating sales leads from a plurality of online sources.

### BACKGROUND

Contracts between public sector purchasers and private sector suppliers of goods and services are annually worth upwards of ten and fifty billion dollars, respectively. Yet the acquisition process is often complicated, as well as costly for prospective private sector suppliers. Unlike ordinary commercial contracts between private entities, government contracts are usually tightly regulated in order to increase the transparency of the bidding process. The regulatory cost involved is usually borne by the private suppliers.

The high cost of bidding on government contracts is further due to the growing bureaucracy of modern governments. Within the various branches of government, governmental authority is further segmented into more or less autonomous agencies or organizations, each one potentially publicizing sales leads using different methods. This governmental bureaucracy further increases the costs of private suppliers because certain costs are involved each time a supplier must adapt to a new and different method of publishing sales leads (such as requests for bids, proposals, tenders, or the like).

In the United States, legislative efforts have recently been made to simplify and streamline the acquisition process. The legislative efforts focused on easing formal publication requirements for sales leads as a way to make them more readily accessible to private suppliers. In particular, the amendments established a centralized Electronic Data Interchange (EDI) in the United States, known as the Federal Acquisition Network (FACNET), in order to replace past publication sources. However, ineffective technology limited the usefulness of this initiative.

Electronic publication of government sales leads has, to some extent, ameliorated the acquisition process. Nevertheless, formidable barriers for private suppliers remain in place. In particular, government agencies and departments now can use any suitable EDI in order to publicize sales leads. Each such EDI may potentially involve different procedures and different access requirements. As a result, sales leads are presently publicized in thousands of unique sources. Different technologies are involved from source to source and private sector suppliers are required to adapt to those different technologies at significant cost.

Until the acquisition process can be simplified and streamlined at source, private sector suppliers will continue to bear unnecessary cost.

### SUMMARY OF THE INVENTION

According to a first aspect of the present invention, a method for generating sales leads information from a plurality of online sources is provided. The method comprises the following steps:

collecting the sales lead information from the plurality of online sources;

transforming the sales leads information into a data record;

classifying the data record containing the sales lead information according to at least one predetermined characteristic; and
storing the data record.

According to a second aspect of the invention, a system for generating sales lead information from a plurality of online sources is provided. The system comprises a data collector module, a data processor module, a translation mapping engine, and a data store. The data collector module is adapted to collect the sales lead information from the plurality of online sources. The data processor module is adapted to transform the sales lead information into a data record. The translation mapping engine is adapted to classify the data record containing the sales lead information according to at least one predetermined characteristic. The data store adapted to store the data record.

### BRIEF DESCRIPTION OF DRAWINGS

Exemplary embodiments are described below in further detail, with reference to the accompanying drawings, in which:

FIG. 1 is a block diagram of a system for generating a database of sales leads from online sources according to an embodiment of the present invention;

FIG. 2 schematically illustrates mapping of foreign industry codes into unified a industry code;

FIGS. 3a to 3c schematically illustrate alternative configurations of a Bayesian filter that may be used for code mapping;

FIG. 4 is a flow chart illustrating a method for collecting sales leads from online sources where the online sources are XML files stored on remote servers that are accessible via HTTP;

FIG. 5 is a flow chart illustrating a method for collecting sales leads from online sources where the online sources are XML files stored on remote servers that are accessible via FTP;

FIG. 6 is a flow chart illustrating a method for collecting sales leads from online sources where the online sources are CSV files attached to e-mails that are receivable using SMTP;

FIG. 7 is a flow chart illustrating a method for aggregating unique data records into a database; and

FIG. 8 is a flow chart illustrating a method for disaggregating obsolete data records from a database.

### DETAILED DESCRIPTION OF EMBODIMENTS

While the embodiments of the invention described herein are implemented in software that runs on network servers, it will be obvious to those skilled in the art that the present invention may be implemented in any other suitable embodiments. Such embodiments may include alternative software implementations as well as functionally equivalent hardware implementations.

The embodiments described herein relate to searching, collecting and aggregating sales leads. Typically, these sales leads will be sales leads for government contracts. The leads may also be sales leads for other types of organizations, including without limitation international governmental or non-governmental organizations, large public corporations, and generally any other organization that may periodically and openly publicize sales leads in order to solicit bids, proposals, tenders, or the like. As used herein, “sales leads” means requests for invitation to bid, invitations to quote, requests for quotation, requests for proposals, bids, proposals, tenders, or the like.

The methods and systems according to an embodiment of the present invention are adapted to generate sales leads from a plurality of online sources by incorporating parallel functionalities.

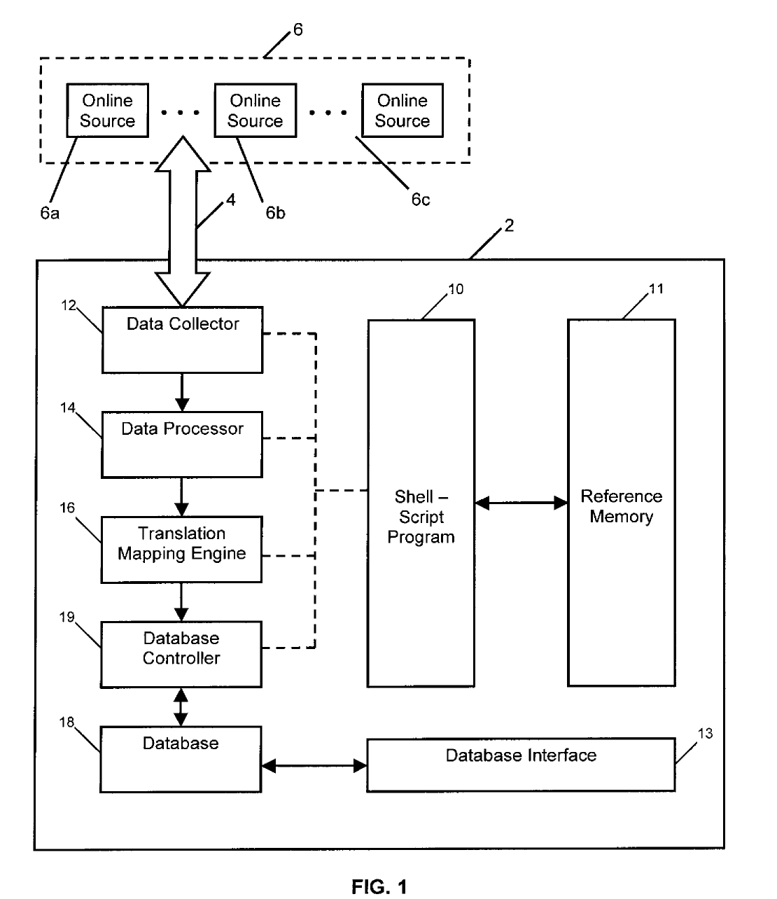

Reference is now made to FIG. 1, in which is illustrated a system 2 for generating sales leads from a plurality of online sources 6a-c, according to an embodiment of the present invention. For example, online source 6a may be an Extensible Markup Language (XML) file accessible using Hypertext Transfer Protocol (HTTP). Online source 6b may be an XML file accessible using a File Transfer Protocol (FTP) site. Online source 6c may be a Comma Separated Variable (CSV) file attached to an email receivable using Simple Mail Transfer Protocol (SMTP). Although for clarity, only three online sources 6a-c are shown in FIG. 1, it will be understood by those skilled in the art that the system 2 may generate sales leads from any number on online sources. The individual online sources 6a-c will be collectively referred to as a “plurality of online sources” and identified by part number 6.

The system 2 communicates with the plurality of online sources 6 via a communication network 4. The communication network 4 may be any communication network across which the system 2 may interface with the plurality of online sources 6. For example, the network 4 may be the Internet, a local area network, a wide area network, a wireless network, or any other suitable communication network. The system 2 may communicate with the plurality of online sources 6 over the communication network 4 using any suitable network communication protocol, such as Transmission Control Protocol/Internet Protocol (TCP/IP), Hypertext Transfer Protocol (HTTP), Secure Hypertext Transfer Protocol (HTTPS), File Transfer Protocol (FTP), Secure File Transfer Protocol (FTPS), Simple Mail Transfer Protocol (SMTP). In various embodiments, the system 2 may communicate with online sources 6 using one or more of the above protocols.

The plurality of online sources 6 may be located on or originate from one or more remote servers that are accessible by the system 2 via the communication network 4. The online sources 6 may correspond to one or more of the various EDIs in which sales leads may be publicized. Sales leads may be electronically publicized by means of any suitable data structure or type, in any suitable file format, such as Hypertext Markup Language (HTML), Extensible Markup Language (XML), Personal Home Page (PHP), Active Server Page (ASP), Java Server Page (JSP), Comma Separated Variable (CSV), Text (TXT), or Excel (XLS).

The system 2 preferably includes the functionality to: search EDIs for publicized sales leads and collect them onto a local server; classify sales leads according to one or more characteristics of the sales leads; generate data records that correspond to the sales leads; update fields of the data records according to the one or more characteristics of the sales leads; and aggregate or disaggregate data records into or from a database. The system 2 may be implemented as software running on local network servers, or as network accessible hardware. Where it is implemented as software, the system 2 may be programmed in various programming languages, such as C, C++, Java, PHP, or any other suitable programming language.

The system 2 may be implemented as software, hardware, or a combination thereof, as well as being configured in any suitable modular configuration.

In certain embodiments, the system 2 comprises: a shell-script program 10, reference memory 11, a data collector 12, a data processor 14, a translation mapping engine 16, and a database 18. Preferably, the system 2 also includes a database controller 19 and a database interface 13. The above modules are described in more detail below.

The data collector 12 may interface with one or more of the plurality of online sources 6a-c via the network 4 in order to search an EDI for publicized sales leads. The data collector 12 may further collect located sales leads onto a local server. The manner in which the data collector 12 searches and collects sales leads depends on the characteristics of the particular online source 6a-c.

The data collector 12 is capable of collecting sales leads from a plurality of online sources 6 where each source provides data in different data/file formats, such as HTML, XML, PHP, ASP, or JSP.

Where the online sources 6 comprise the above-mentioned file formats, the data collector 12 may be a web crawler, a cURL program, or a collection of one or more of the above. As used herein, the term “cURL program” is also intended to include other cURL-like programs, such as wget, netcat, lynx, urlfetch, as well as PHP fopen( ) functions. The data collector 12 may include a web crawler or cURL program for each online source 6a-c that is accessible using HTTP and other like network communication protocols. Web crawler and cURL programs are suitable implementations of the data collector 12 because they are especially useful for automating unattended file transfers or sequences of operations, including methodical searching of online sources 6. For example, if the URLs of a plurality of online sources 6 are precisely known, then a web crawler or a cURL program may be programmed to sequentially visit the URLs.

Even if the URLs of a plurality of online sources 6 are not precisely known, then a web crawler or a cURL program can be programmed to retrieve information and provide a methodology to log in and preserve a connection to the remote server for each web domain in which some of the URLs within the domain correspond to online sources 6, starting with one or more seed URLs and progressing recursively. In either case, the web crawler or cURL program may download files from the online sources 6 that contain sales leads onto a local server. Web crawler and cURL programs may be written in programming languages, such as C, C++, Java, PHP, or any other suitable programming language.

Sales leads may contain or be accompanied by data in the form of graphical information, such as illustrations, or the like. In such cases, the data collector 12 may collect this additional data along with other data in the sales lead. A web crawler or a cURL program can also be programmed to collect graphical sales leads data.

The data collector 12 is capable of collecting sales leads from a plurality of online sources 6 where the online sources 6 are accessible using different communication protocols. In certain embodiments, the data collector 12 may collect leads from online sources 6 that are located on remote servers that are accessible using HTTP, HTTPS, FTP, FTPS, or any other suitable protocol for establishing a connection between clients and remote servers. In such instance, the data collector 12 may comprise a cURL program or a web crawler that supports these communication protocols. The data collector 12 may alternatively comprise an FTP server client or some other type of network client.

In other embodiments, the data collector 12 may collect sales leads from online sources 6 that are located in e-mails that are accessible using TCP/IP, SMTP, or any other suitable protocol for transmitting and receiving e-mails. In such instance, the data collector 12 may comprise an e-mail server client that supports SMTP, POP, or some other electronic mail protocol. Rather than searching out sales leads, in these embodiments, the data collector 12 may receive sales leads by means of e-mails or attachments to e-mails.

The data collector 12 may also possess additional functionality in order to address other aspects of the accessibility requirements of the online sources 6. For example, access to the online sources 6 may be available to the public at large, but it also may be available to the public only through subscription service, user sessions, or other similar or equivalent means of controlling access. Different embodiments of the data collector 12, therefore, may comprise additional functionality in order to address these different accessibility requirements.

In particular, where the online sources 6 are made available by means of user sessions, then the data collector 12 may further comprise a cookie management program. The purpose of the cookie management program in these instances may be to ensure that the user session remains active, for example by responding to a requesting server by automatically transmitting the appropriate cookie. In various embodiments, the data collector 12 may include cookie management programs or other programs that are similarly utilized in order to ensure continued access to a particular online source 6a-c.

In certain embodiments, it may be useful for the present invention to provide a reliable means for thorough or exhaustive searching and collecting leads from online sources 6. For example, in some embodiments, the data collector 12 comprises a cURL program or a web crawler that searches out sales leads at online source 6a, while in other embodiments the data collector 12 comprises an e-mail server that receives sales leads transmitted from online source 6c. Those embodiments may implement the data collector 12 using software or hardware. It will be understood by those skilled in the art that the specific implementation of the data collector 12 is determined at least in part in response to the different requirements of the online sources 6.

Data for one or more sales leads collected by the data collector 12 from a particular online source 6a-c is stored by the data collector 12 in a file on a local server. Each such file may contain data for one sales lead or each file may contain data for multiple sales leads (such as all sales leads from a particular online source 6a-c), for example organized into an array.

The data processor 14 generates data records from the files stored by the data collector 12. The data processor 14 generates the data records by transforming the data in the files on the local server into one or more corresponding data records, where each data record includes a number of fields. The file for each sales lead or group of leads generated by the data collector 12 may comprise different file formats and different arrangements of data, depending on the characteristics of the plurality of online sources 6.

The file formats from which the data processor 14 generates data records may be those suitable for generating web pages, including HTML, XML, PHP, ASP, and JSP file formats, as well as file formats suitable for storing data records, such as CSV, RTF, and XLS formats. In different embodiments, the data processor 14 may comprise a parser program capable of parsing files that contain sales leads in order to extract the sales leads from the file. The parser program may further be capable of transforming extracted sales leads into equivalent data records.

It is not necessary for the files to contain data or information that is sufficient for the data processor 14 to enter a value for every field in the corresponding data record. Where there is insufficient data or information, the data processor 14 may enter a default value, or it may enter no value.

The data record for each sales lead generated by the data processor 14 consists of a number of fields, including: general description, one or more foreign industry codes, unified industry code, geography code, estimated tender value, publication date, due date, number of bids, and highest bid. These fields are described in more detail below.

The general description provides a description of the sales lead. It may contain written text, illustrations, and other possible means of describing the sales leads. If the sales lead contained any graphical information, then it may be included as part of the general description, but also potentially as a separate field.

The one or more foreign industry codes refers to the industry coding schemes that are variably used to classify sales leads, such as the National Institute of Governmental Purchasing (NIGP), North American Industry Classification System (NAICS), Standard Industrial Classification (SIC), Federal Supply Classification (FSC) codes, and any other coding scheme that may be used. These various coding schemes may be referred to herein as “local coding schemes”. Preferably, the one or more of the foreign industry code schemes are all mapped onto a single industry code scheme developed for the system 2, according to a preferred embodiment of the present invention. This single industry code will be referred to as the “unified industry code”. In certain embodiments, the foreign industry codes may be retained as additional fields in the data record, for example, for searching or browsing purposes.

The geography code refers to the territory to which the sales lead relates. Various geography codes may refer to cities, US counties and states, Canadian municipalities and provinces, countries, protectorates, or any other type of geographical territory that can be designated. In some embodiments, the geography code refers to US states or Canadian provinces. As geographical territory may be designated using different abbreviations or designations, it may be necessary for the data processor 14 to parse different designations for the same territory into a single geographical code. For example, ON, Ont, and Ontario all refer to the same geographical territory.

The estimated tender value refers to the estimated or approximate value of the sales lead. A sales lead may be published either with or without this information. Where this value is omitted, a default estimated tender value may be entered into the data record by the data processor 14. A default value is calculated based on parameters supplied by online sources 6. These sources provide parameters either through stated policies or guidelines. The data processor 14 may also enter no value into the field.

The publication date refers to the date on which the sales lead was first publicized. The due date refers to the date by which bids on the tender offer must be received. A sales lead may be published either with or without this information. Where these dates are omitted, default dates may sometimes be entered into the data record by the data processor 14. A default value is calculated based on parameters supplied by online sources 6. These sources provide parameters either through stated policies or guidelines. The data processor 14 may also enter no value into the field.

The number of bids refers to the total number of bids tendered on the sales lead to date and the highest bid refers to the highest bid tendered on the sales lead to date.

Embodiments of the present invention may utilize data records that include any combination of the above described fields or other suitable fields relating to sales leads.

Though described herein as separate modules, the functionalities of the data collector 12 and the data processor 14 may, in some embodiments, be combined. For example, the data processor 14 may operate intermediately by parsing the file in which the sales lead is stored remotely. In this manner, the data collector 12 may collect only the sales lead itself onto the local server and not the entire file in which the sales lead is stored.

Continuing to refer to FIG. 1, the translation mapping engine 16 preferably performs two related functions. First, it classifies sales leads according to at least one predetermined characteristic of the sales leads, such as the unified industry code. Second, it updates one or more fields in the data records that correspond to sales leads according to a set of mapping rules that are based, at least in part, on the predetermined characteristics of the sales leads. Specifically, the sales leads are classified into industry sectors by way of one or more foreign industry codes and the set of mapping rules correlates the one or more foreign industry codes to the unified industry code.

52 Preferably, the code mapping performed by the translation mapping engine 16 does not involve only a one-to-one correlation between values in the two respective industry codes. It is not necessary for only one single value in a foreign industry code to map onto only one single value in the unified industry code. Rather, a single value in a foreign industry code potentially can map onto a plurality of values in the unified industry code, and a plurality of values in a foreign industry code potentially can map onto a single value in the unified industry code. Embodiments of the present invention may utilize mapping rules that can be generalized to result in any suitable code mapping.

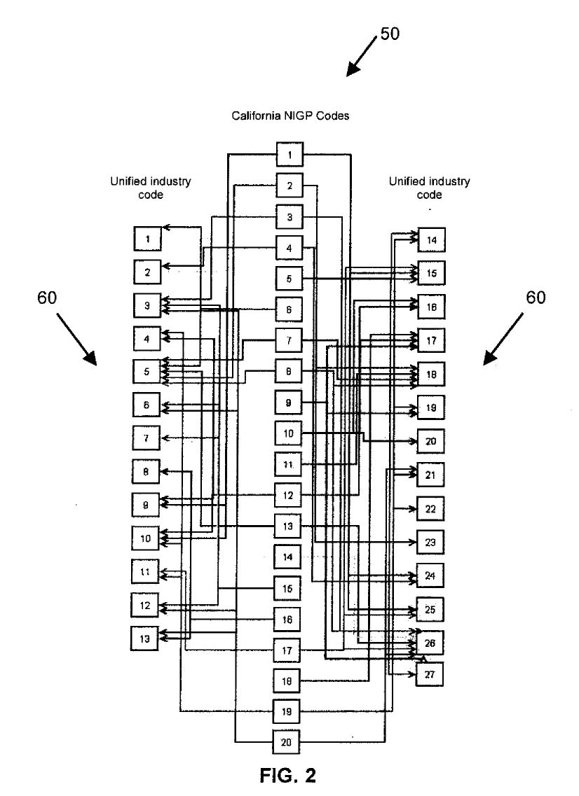

Reference is now made to FIG. 2, in which are schematically illustrated exemplary code mapping rules. In this particular example, the foreign industry code mapped onto the unified industry code 60 is the California State NIGP code 50. As illustrated, the mapping rules are generalized in the sense that certain multiple values in California State NIGP code 50 may map onto a certain single value in the unified industry code 60. For example, California NIGP code values [1] and [12] both map onto unified industry code value [9]. Likewise in at least one instance, a certain single values in California State NIGP code 50 may map onto certain multiple values in the unified industry code 60. For example, California NIGP code value [8] maps onto unified industry code values [5], [18] and [26].

Preferably, the code mapping performed by the translation mapping engine 16 does not remain fixed over time. Foreign industry codes may periodically be—and indeed frequently are—updated at source. Where that is the case, if the outcome of the code mapping is to remain as it was before the foreign industry codes were updated, then the mapping rules that the translation mapping engine 16 applies must be updated accordingly. Similarly, unified industry codes may also periodically be updated in response to, for example, demands from users. Embodiments of the present invention, therefore, comprise a translation mapping engine 16 that is capable of updating its mapping rules.

In one embodiment, the translation mapping engine 16 may be implemented as a look-up table, which may be stored, for example, in reference memory 13. When the translation mapping engine 16 is to update a data record, it may do so by: reading a value in the data record that refers to a foreign industry code; searching for the corresponding entry in the look-up table; reading the entry for the value or values of the unified industry code that correlates with the foreign industry code; and then entering the unified industry code into the data record. If the translation mapping engine 16 is unable to locate the foreign industry code within the look-up table, it may enter no value into the data. In some embodiments, the mapping rules may also be stored in reference memory 13. In other embodiments, the mapping rules are stored in other data structures.

The mapping rules may be static or dynamic. In some embodiments, the mapping rules are static and, as such, are capable only of manual update. Static mapping rules do not automatically update themselves in response to updates in foreign industry mapping codes. Where foreign industry codes have been updated and it is desired to update the mapping rules accordingly, then the update must be detected, analyzed, and manually incorporated into a new set of mapping rules. For example, where the mapping rules are stored in a look-up table, then appropriate entries of the lookup table must be modified.

In other embodiments, the mapping rules are dynamic and, as such, are capable of automatic update. Where foreign industry codes have been updated and it is desired to update the mapping rules accordingly, then dynamic mapping rules allow for automatic detection, analysis and incorporation of the update into the current set of mapping rules to provide a new set of mapping rules. In particular, dynamic mapping rules may update themselves with only minimal or no reference to foreign industry codes. As these codes can potentially be updated without notice, the reliance that dynamic mapping rules can place on such codes may be limited. Any algorithm that is capable of implementing dynamic mapping rules may be implemented in the mapping engine 16.

In one embodiment of the present invention, a Bayesian filter is used to implement dynamic mapping rules in the translation mapping engine 16. A Bayesian filter is a method of estimating the real value of an observed variable that evolves over time using seed data and keyword analysis. In this embodiment, the variable is a foreign industry code. For example, in the case of sales leads, a Bayesian filter might detect repeated use of the same words or phrases or language within sales leads and use this information to assign a corresponding unified industry code to a particular sales lead.

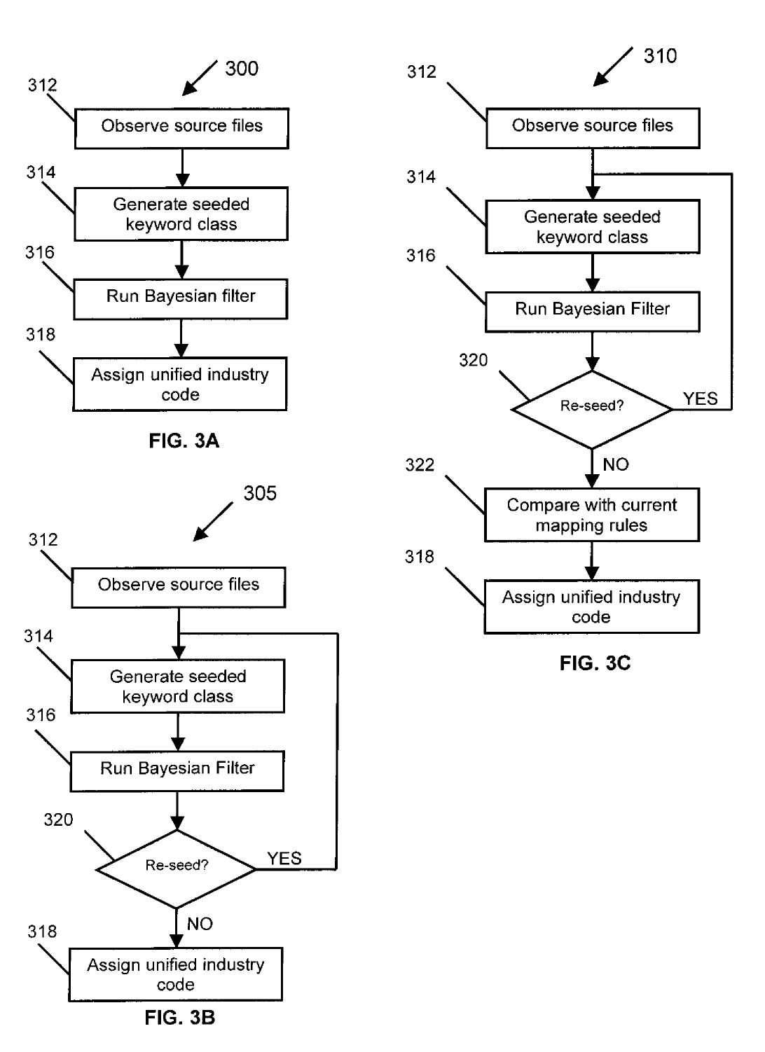

Reference is now made to FIGS. 3a to 3c, in which are illustrated three alternative configurations of a Bayesian filter algorithm that may be implemented in embodiments of the present invention. FIG. 3a shows a single-seed Bayesian filter algorithm 300. At step 312, the Bayesian filter observes past and present source files, in this case sales leads. At step 314, the Bayesian filter generates a single seeded class of key words, where words in the class correlate to different values of the unified industry code. At step 316, for a particular sales lead, the Bayesian filter estimates a value for the unified industry code based on key word analysis of the sales lead. At step 318, the Bayesian filter assigns the estimated unified industry code to the sales lead.

FIG. 3b shows a multiple-seed Bayesian filter algorithm 305, which is similar to the single-seed Bayesian filter algorithm 300. Like steps in FIG. 3b are assigned like reference numbers and will not be further described. At step 314, more then one seeded class of key words may be generated for use in step 316. One class is generated initially based only on observation of source files in step 312, and other classes thereafter based on a re-seeding of the outcome of step 316. The decision as to whether to re-seed the outcome of step 316 is made by the operator, as illustrated in decision diamond 320. Re-seeding may be performed any number of times as desired, but is performed only once in certain embodiments of the present invention.

FIG. 3c shows a multiple-seed Bayesian filter algorithm 310, which is similar to the multiple-seed Bayesian filter algorithm 305. Like steps in FIG. 3c are assigned like reference numbers and will not be further described. The algorithm 310 differs from algorithm 305 in that that it incorporates post-filtering at step 322. Specifically, after re-seeding 320 is completed, the outcome of step 316 is compared with current mapping rules (or a simplified set of current mapping rules) as an error-checking mechanism.

In certain embodiments, the translation mapping engine 16 may utilize a Bayesian filter algorithm to implement dynamic mapping rules. Such algorithm may comprise single-seed Bayesian filter algorithm 300 or multiple-seed Bayesian filter algorithms 305,310.

The means by which the translation mapping engine 16 classifies the plurality of sales leads 6 depends on the manner in which the translation mapping engine 16 is implemented. For example, where the mapping rules are static and stored as a look-up table, then classification of sales leads is based on the observation of foreign industry codes. The foreign industry code associated with the sales lead is presumed to correlate with the unified industry code that is stored in the look-up table.

Where the mapping rules are dynamic and updated iteratively with the use of a Bayesian filter, such as in algorithms 300,305,310, then classification of sales leads is the outcome of the Bayesian filter algorithm. The Bayesian filter determines what unified industry code most likely correlates to the foreign industry code. As discussed above, the Bayesian filtering algorithm may not provide accurate results in every instance and may also make use of a current set of mapping rules.

Therefore, whether the mapping rules are static or dynamic, there is always the potential for classification of sales leads to contain undetected errors. Foreign industry codes may be improperly correlated with the unified industry codes and filtering may not be perfectly accurate. Accordingly, the translation mapping engine 16 may also incorporate one or more error-checking mechanisms, such as periodic manual auditing of the outcome of the translation mapping engine 16, in order to discover and correct these undetected errors.

Referring again to FIG. 1, the database 18 contains data records that correspond to sales leads that have been collected from a plurality of online sources 6. In some embodiments, management of the database 18 may be provided by a database controller 19 and access to the database 18 may be provided by a database interface 13.

The system 2 may also include a shell-script program 10 that is capable of automating some or all of the functionality of the system 2 and its constituent modules, including the data collector 12, the data processor 14 and the translation mapping engine 16. The shell-script program 10 may access a script that has been written and stored, for example, in reference memory 11. Such a script may contain a complete sequence of instructions to be executed by the system 2. The shell-script program 10 may be written in any suitable programming language, such as C, C++, Java, or PHP.

One or more scripts may be required by the shell-script program 10. Each script may be programmed with reference to a particular online source within the plurality of online sources 6. Each script may then be stored, for example, in reference memory 11. The shell script program 10 may then read a script from reference memory 11 which corresponds to one of the online sources 6a-c.

It will be understood by those skilled in the art that shell-scripting is only one possible means of automating the system 2, and that any other suitable automation means may be used.

The operation of the system 2 will now be described in accordance with various embodiments of the present invention.

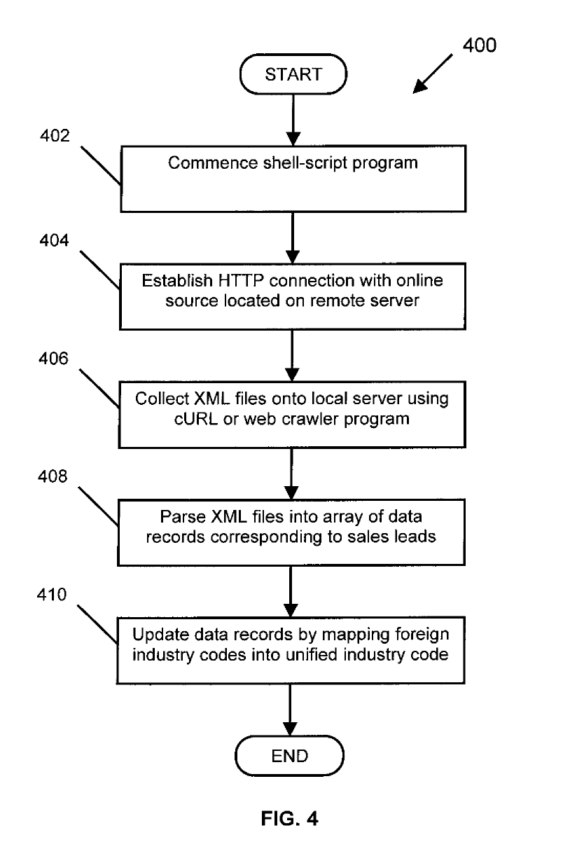

Reference is now made to FIG. 4, in which is illustrated a flowchart for a method 400 (according to an embodiment of the present invention) for collecting sales leads onto a local server from online source 6a, which corresponds to XML files stored on remote servers that are accessible using HTTP.

Step 402 comprises commencing the shell-script program 10 in order to automate the steps of method 400. The script executed by the shell-script program 10 may be written in PHP. The shell-script program 10 may be commenced at any suitable frequency or interval.

Commencement of the shell-script program 10 may also itself be automated. In one embodiment, the shell-script program 10 is commenced at regular intervals, for example once daily, using a CRON command. The shell-script program 10, reading the appropriate script from reference memory 11 may execute step 402.

In step 404, the data collector 12, in response to commands from the shell-script program 10, establishes an HTTP connection with a remote server corresponding to online source 6a. In order to make the HTTP connection, a web crawler or a cURL program may be used.

In step 406, the data collector 12, in response to commands from the shell-script program 10, collects the XML files containing the sales leads located on the online source 6a using a web crawler or a cURL program.

In step 408, the data processor 14, in response to commands from the shell-script program 10, parses the XML files into an array of data records where each data record in the array corresponds to a sales lead. Parsing XML files involves isolating sales leads with the files and converting them into equivalent data records, which may be implemented, for example, by an appropriate script.

In step 410, the mapping engine 16, in response to commands from the shell-script program 10, updates the array of data records by mapping foreign industry codes onto one or more unified industry codes and entering the one or more unified industry codes into the appropriate corresponding field of the data record. Code mapping may require the sales leads to first be classified according to industry sector using either static or dynamic mapping rules.

Method 400 ends with the generation of a complete data record that corresponds to a sales lead and that remains to be aggregated into database 18 if desired.

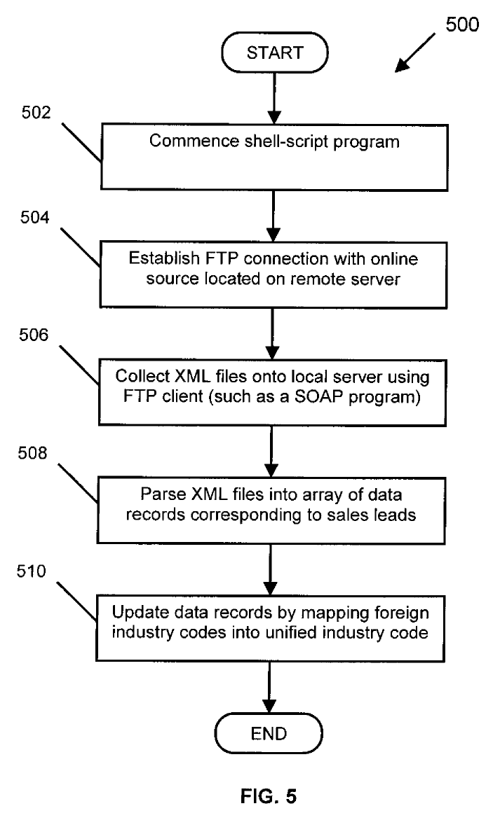

Reference is now made to FIG. 5, in which is illustrated a flowchart for a method 500 (according to an embodiment of the present invention) for collecting sales leads onto a local server from online source 6b, which corresponds to XML files stored on remote servers that are accessible using FTP.

Step 502 is substantially identical to step 402 and will not be further described.

In step 504, the data collector 12, in response to commands from the shell-script program 10, establishes an FTP connection with a remote server corresponding to online source 6b. In order to make the FTP connection, an FTP client or any other program or application that supports FTP may be used.

In step 506, the data collector 12, in response to commands from the shell-script program 10, collects the XML files using the FTP client, such as a Simple Object Access Protocol (SOAP) program.

Steps 508 and 510 are substantially identical to steps 408 and 410, respectively, and will not be further described

Method 500, like method 400, ends with the generation of a data record that corresponds to a sales lead and that remains to be aggregated into database 18 if desired.

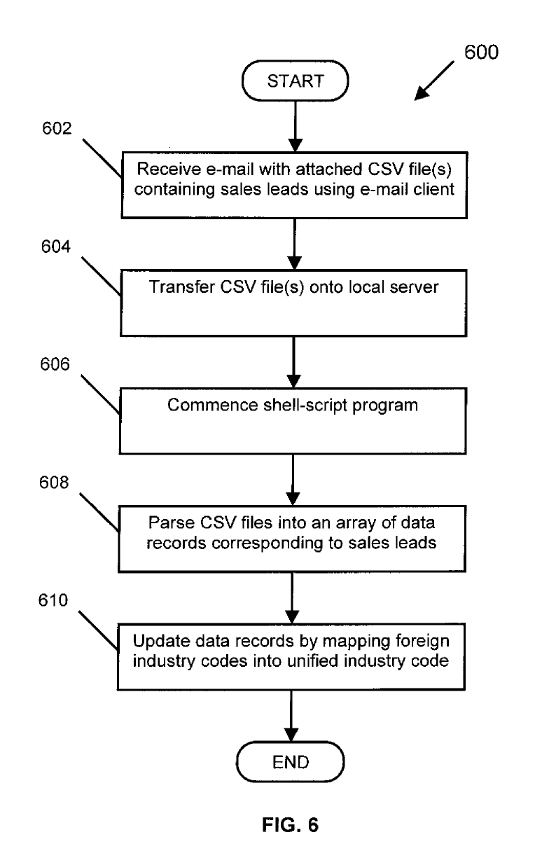

Reference is now made to FIG. 6, in which is illustrated a flowchart for a method 600 (according to an embodiment of the present invention) for collecting sales leads onto a local server from online source 6c, which corresponds to CSV files attached to e-mails that are receivable using SMTP.

In step 602, the data collector 12 receives an e-mail to which is attached one or more CSV files. In order to receive the e-mail, an e-mail client or any other program or application that supports SMTP may be used.

In step 604, the data collector 12 transfers the CSV files onto the local server. In order to transfer the attached one or more CSV files, an e-mail client or any other program or application that supports SMTP may be used.

Step 606 comprises commencing the shell-script program 10 using a CRON command in order to automate some or all of the remaining steps of method 600. The script executed by the shell-script program 10 may be written in any suitable programming language. In one embodiment, the script is written in PHP.

In step 608, the data processor 14, in response to commands from the shell-script program 10, parses the collected CSV files into an array of data records where each data record in the array corresponds to a sales lead. Step 608 is substantially the same as step 408 from method 400 and step 508 from method 500, in that parsing CSV files involves isolating sales leads within the files and converting them into equivalent data records.

Step 610 is substantially identical to step 410 and will not be further described.

Method 600, like methods 400 and 500, ends with the generation of a data record that corresponds to a sales lead and that remains to be aggregated into database 18 if desired. Though described with reference to exemplary embodiments, method 600 may be adapted to other embodiments, such as where the files attached to the received e-mails are file formats other than CSV.

Methods 400, 500, and 600 each describe exemplary embodiments of the present invention. The precise arrangement and inclusion of steps within methods may be varied in other possible embodiments. For example, code mapping that takes place in steps 410, 510, and 610 may be performed earlier in the method at any point after the sales leads have been extracted. Moreover, parsing of sales leads into a data record in steps 408, 508, and 604 may be combined with collecting sales leads in steps 406, 506 and 606 respectively. The above two examples are only two possible examples of the manner in which the embodiments of methods 400, 500, and 600 may be varied.

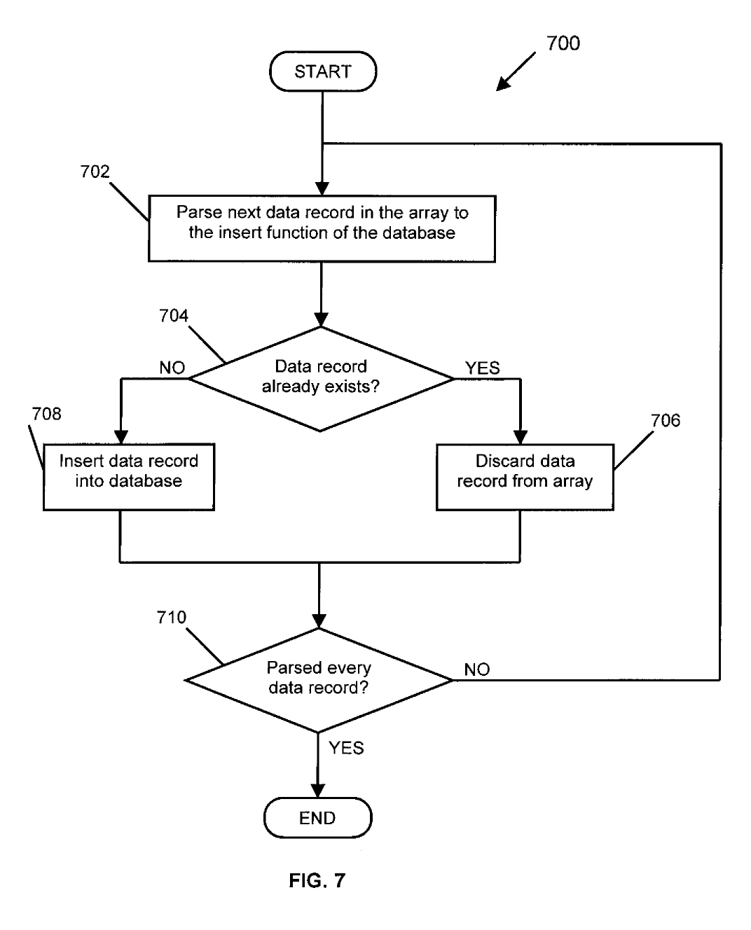

Reference is now made to FIG. 7, in which is illustrated a flowchart for a method 700 for aggregating data records of sales leads into a database, according to an embodiment of the present invention. Method 700 may be used in conjunction with any of methods 400, 500 or 600, according to embodiments of the present invention.

In step 702, the database controller 19 parses the next data record in an array of data records to the insert function of the database 18. The insert function is used by the database 18 to aggregate data records into the database and may be implemented by a database controller 19, or any other suitable database management program.

In decision diamond 704, the database controller 19 determines whether or not the data record that was parsed to the insert function of the database 18 is equivalent to a data record that already exists in the database 18. Where it is determined that a data record already exists in the database 18 that is equivalent to the parsed data record, then method 700 proceeds to step 706 where the parsed data record is discarded from the array. If it is determined that the parsed data record is unique, then method 600 proceeds to step 708 where the data record is inserted into the database 18. From either step 706 or step 708, method 700 proceeds to decision diamond 710.

In decision diamond 710, the database controller 19 determines whether or not every data record in the array of data records has been parsed to the insert function of the database 18. Where it is determined that not every data record in the array of data records has been parsed to the insert function, then method 700 returns to step 702. However, where it is determined that every data record in the array of data records has been parsed to the insert function, the method 700 ends.

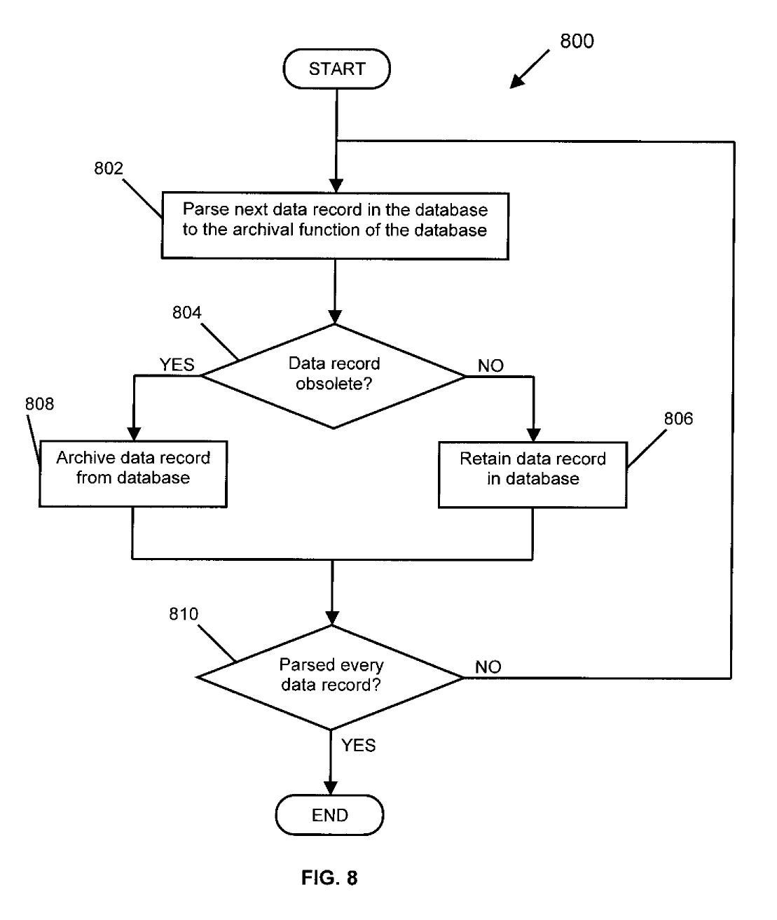

Reference is now made to FIG. 8, in which is illustrated a flowchart for a method 800 for disaggregating data records from a database, according to an embodiment of the present invention. Method 800 may be used in conjunction with any of methods 400, 500 or 600, according to embodiments of the present invention.

In step 802, the database controller 19 parses the next data record in the database 18 to an archival function of the database 18. The archival function is used by the database 18 to disaggregate data records from the database into an archive and may be implemented by a database controller 19, but also by any other suitable database management program.

In decision diamond 804, the database controller 19 determines whether or not the data record that was parsed to an archival function of the database 18 has become obsolete. If the parsed data record has not become obsolete, then method 800 proceeds to step 806 where the parsed data record is retained in the database 18. However, where it is determined that the parsed data record has become obsolete, then method 800 proceeds to step 808 where the data record is archived from the database 18. From either step 806 or step 808, method 800 proceeds to decision diamond 810.

In decision diamond 810, the database controller 19 determines whether or not every data record in the database 18 has been parsed to the archival function of the database 18. Where it is determined that not every data record in the database 18 has been parsed to the archival function, then method 800 returns to step 802. However, where it is determined that every data record in the database 18 has been parsed to the archival function, the method 800 ends.

Method 700 for aggregating data records into a database and method 800 for disaggregating data records from a database may be used in embodiments of the present method and system as a means of maintaining the integrity and currency of database 18.

It will be apparent to those skilled in the art that changes and modifications to the described embodiments may be made without departing from the substance and scope of the described embodiments.

1. A method for generating sales lead information from a plurality of online sources, the method comprising:
collecting the sales lead information from the plurality of online sources;
transforming the sales leads information into a data record;
classifying the data record containing the sales lead information according to at least one predetermined characteristic; and
storing the data record.

2. The method of claim 1, wherein the storing step further comprises storing the data record on a database

3. The method of claim 2, further comprising making the database available online to users.

4. The method of claim 1, wherein each of the plurality of online sources is selected from the group comprising: network sites, FTP servers and e-mails.

5. The method of claim 1, wherein the at least one predetermined characteristic is selected from the group comprising: industry sector, geography and tender value.

6. The method of claim 1, wherein the classification step further comprises mapping a first industry code associated with a first field in the data record to a second industry code, wherein the first industry code is derived from a first coding scheme and the second industry code is derived from a second coding scheme.

7. The method of claim 6, wherein the second coding scheme is a unified coding scheme for industry codes, wherein the first coding scheme is a local coding scheme for industry codes, wherein at least a portion of the data records comprises the second industry code associated with the unified coding scheme.

8. The method of claim 6 wherein the classification step is performed using a Bayesian keyword filter.

9. The method of claim 1, wherein each of the plurality of online sources is selected from the group comprising: XML files accessible using HTTP, XML file accessible using FTP, and CSV file receiveable via SMTP.

10. The method of claim 1, further comprising commencing a shell script program to automatically execute subsequent steps.

11. A system for generating sales lead information from a plurality of online sources, the system comprising:
a data collector module adapted to collect the sales lead information from the plurality of online sources;
a data processor module adapted to transform the sales lead information into a data record;
a translation mapping engine adapted to classify the data record containing the sales lead information according to at least one predetermined characteristic; and
a data store adapted to store the data record.

12. The system of claim 11 wherein the data store comprises a database and a database interface adapted to make the database available online to users.

13. The system of claim 11, wherein the data collector module is selected from the group comprising: a web crawler, a cURL program and a data parser.

14. The system of claim 11, wherein the data collector module further comprises a cookie management program, wherein the cookie management program is adapted to maintain a user session in an active state.

15. The system of claim 13, wherein the data parser is adapted to parse a file containing the sales lead information in order to extract the sales lead information from the file.

16. The system of claim 11, wherein the translation mapping engine is implemented as a Bayesian keyword filter.

17. The system of claim 11, wherein the data record comprises a plurality of fields, wherein each field is selected from the group comprising: industry code, geography code, estimated tender value, publication date, due date, number of bids, and highest bid.

18. The system of claim 11, wherein the translation mapping engine is adapted to map a first industry code associated with a first field in the data record to a second industry code, wherein the first industry code is derived from a first coding scheme and the second industry code is derived from a second coding scheme.

19. The system of claim 18, wherein the second coding scheme is a unified coding scheme for industry codes, wherein the first coding scheme is a local coding scheme for industry codes, wherein at least a portion of the data records comprises the second industry code associated with the unified coding scheme.

20. The system of claim 11, wherein the translation mapping engine is implemented as a lookup table.

21. The system of claim 11, further comprising a shell script program adapted to execute a script corresponding to one of the plurality of online sources.
